(19) United States
(12) Patent Application Publication
(10) Pub. No.: US 2008/0204766 A1
(43) Pub. Date: Aug. 28, 2008

(54) METHOD AND MICROSCOPE DEVICE FOR OBSERVING A MOVING SPECIMEN

(75) Inventor: Rainer UHL, Graefelfing (DE)

Correspondence Address: ROBERTS MLOTKOWSKI SAFRAN & COLE, P.C., P. O. BOX 10064, MCLEAN, VA, 22102-8064, US

(73) Assignee: TILL I.D. GMBH, Graefelfing (DE)

(21) Appl. No.: 12/037,633

(22) Filed: Feb. 26, 2008

(30) Foreign Application Priority Data
Feb. 27, 2007 (DE) 10 2007 009 550.5

(51) Int. Cl. G01B 11/14; G02B 21/06

(52) U.S. Cl. 356/615; 359/385

(57) ABSTRACT

There is provided a microscope device comprising an objective, a light source for illuminating a specimen via an illumination beam path, an arrangement for continuously moving the specimen during observation in a direction perpendicular to the optical axis of the objective, a two-dimensional detector for detecting light coming from the specimen via an image beam path, said detector being capable of shifting charges during observation in a row-wise manner in the direction of the movement of the specimen on the detector, a beam deflection element which is adjustable for moving the illumination beam path and the image beam path during observation relative to the specimen in the direction of the movement of the specimen, and a control unit for selecting the velocity of the specimen, the adjustment velocity of the beam deflection element and the charge shift velocity in such a manner that the charge shift velocity acts to compensate the movement of a point of the specimen, which point is imaged onto the detector, on the detector.

### BACKGROUND OF THE INVENTION

1. Field of the Invention

The invention relates to a microscope device comprising an electronic two-dimensional sensor (charge coupled device (CCD) or CMOS)) for observing a moving specimen and to a corresponding observation method. The invention also relates to an incoherent microscope illumination arrangement having maximized brightness.

2. Description of Related Art

If one wishes to analyze a moving specimen by using a conventional microscope device, one encounters the problem that the specimen moves also on the detector and hence the image of the specimen would “blur” in space for longer exposure times. In order to avoid such problem, it is known to use so-called TDI (Time Delayed Integration) methods, wherein during exposure a row-wise charge displacement occurs on the image sensor chip, which displacement has to be exactly synchronized with the velocity of the specimen.

Longer exposure times are required in particular for investigations using fluorescence analysis, since the signals measured therein are small, and for achieving a good signal to noise ratio many exciting photons are required. If these photons are applied during a too short time period (for example by stroboscope illumination), the required photon flux densities cause secondary photochemistry and hence result in damage of the specimen. Therefore, in most cases stationary specimens are investigated by means of the microscope, and the excitation energy is distributed over longer time periods.

However, a continuously moved specimen always is beneficial in case that high specimen throughput is important. For example, cell-based screening assays can be significantly accelerated by using a continuously moving specimen. Moreover, the cells, which suffer from the acceleration forces occurring in the usual “top and go”-operation, are spared. Such devices are described, for example, in Netten et al. (1994) Bioimaging, Vol. 2, No. 4, pages 184-192.

From US 2001/012069 A1, U.S. Pat. No. 6,545,265 B1 and DE 102 06 004 A1 microscope devices are known, wherein moving specimens are investigated by using TDI sensor chips and wherein the microscope is designed for obtaining confocal images. Confocal microscopes usually are designed such that the excitation light passes through a mask which is imaged onto the specimen, and the light collected by the objective likewise passes through a mask prior to impinging on the detector. The mask arranged in the image beam path may be a separate mask, or it may be the same mask as the mask arranged in the illumination beam path. Thereby it can be prevented that light which does not originate in the focal plane of the objective reaches the detector, since such light is not imaged onto the mask arranged in the image beam path. Thereby a certain depth resolution of the microscope can be achieved.

Since a confocal microscope does not allow to illuminate the entire specimen at the same time (illumination takes place only at the bright spots of the illumination pattern generated by the mask arranged in the illumination beam), the illumination pattern has to be moved relative to the specimen in order to image the entire specimen. According to US 2001/012069 A1 and DE 102 06 004 A1, to this end the specimen is moved relative to the microscope objective, while the illumination pattern is stationary with regard to the microscope. The TDI sensor chip serves to compensate the movement of the specimen in order to maintain sufficient lateral resolution. The relative movement between the illumination pattern and the specimen, however, occurs in such a manner that each point of the specimen is illuminated exactly for the same time period. Such an embodiment is also described in U.S. Pat. No. 6,545,265 B1, wherein in addition an alternative embodiment is described, wherein the specimen is fixed in space and the illumination pattern is moved across the specimen by moving the mask. This mask also serves as a confocal aperture for the image beam path. Since the specimen in this case does not move on the detector, no TDI sensor ship is required.

From U.S. Pat. No. 6,310,687 B1 a method for wide field illumination of a specimen moving relative to the microscope is known, wherein it is ensured by a corresponding mechanical design of the microscope that the illumination beam and the image beam exactly follow the moving specimen. Due to this follow-up movement the specimen is imaged onto the detector in a stationary manner, so that no TDI sensor is required.

Detectors which have been manufactured specifically for TDI operation with variable row shift frequency usually are optimized for illumination modes which involve high photon flux densities. Hence, such detectors usually have a larger reading noise than detectors, which are optimized for low-light fluorescence measurements and the row frequency of which cannot be freely selected.

It is an object of the invention to provide for a microscope device and a method for observing a moving specimen, which device and method, respectivly, can be adapted to the given measurement requirements as well as possible.

### SUMMARY OF THE INVENTION

According to the invention this object is achieved by a microscope device as defined in claims 1 and 2, respectively, and by corresponding methods as defined in claims 18 and 19, respectively.

According to the solution of claims 1 and 18, on the one hand charge shift occurs on the detector and on the other hand the illumination beam path and the image beam path, i.e. the image field illuminated by the light source and imaged onto the detector, are moved during observation relative to the specimen into the direction of the specimen movement by means of the adjustable beam deflection element in such a manner that the velocity of the charge shift acts to exactly compensate the movement of a point of the specimen on the detector. This is beneficial in that a very high flexibility is achieved in that the velocity of the charge shift (“TDI velocity”), unlike in the prior art, has no longer to exactly correspond to the specimen velocity, but rather it can be selected essentially freely, since only the sum of specimen movement, adjustment velocity of the beam deflection element and charge shift velocity is fixed. In particular, thereby detectors may be used whose row frequency cannot be freely selected (unlike usual TDI chips whose row frequency can be freely selected), whereby lower reading noise and lower costs can be achieved. Moreover, due to the adjustable beam deflection element it is possible to successively view the same portion of a moving specimen twice or more times, for example, prior to and after addition of a substance to be tested.

The solution according to claims 2 and 19 utilizes the effect that, by making the illumination beam path and the image beam path partially follow the specimen movement, the velocity of the specimen on the detector can be kept so small, irrespective of the velocity of the specimen relative to the objective, that the specimen does not blur within the exposure time required for taking an intermediate image, i.e. that the image of the specimen on the detector moves, for example, for less than half of the width of a diffraction limited row of the detector. Thereby the specimen movement on the detector may be compensated by a corresponding row-wise shift of the intermediate images relative to each other when combining the intermediate images for creating the final image, without a TDI camera being necessary.

According to a second aspect the invention relates to an incoherent illumination arrangement for a microscope requiring structured illumination, in particular for a confocal microscope. In confocal microscopy, as shown, for example, in FIGS. 1 to 3, the respective areas of the specimen are exposed to the illumination light, i.e. to the bright areas of the illumination pattern imaged onto the specimen, not during the entire measuring time, but rather the effective exposure time is reduced by the time during which the respective specimen areas are located in the dark areas of the illumination pattern, i.e. the effective exposure time is reduced by the “filling factor” of the illumination pattern. The better the desired confocality should be, the smaller this filling factor has to be, i.e. the shorter the effective exposure time has to be.

When using coherent, i.e. laser, light sources, the reduced exposure time may be compensated by correspondingly increasing the local illumination intensity by using, for example, microlenses, which provide for a concentration (focussing) of the illumination light in the transparent portions of the illumination mask (hereinafter the areas of the illumination mask which are transparent for the illumination light shall be designated, for the sake of simplicity, “openings”, irrespective of whether in these areas the mask material actually is cut through or only is transparent). If the illumination mask is fixed, a simple microlens array (or a cylinder lens array for specimen scanning by means of parallel stripes, (“slit scan” methods)) or a holographic optical element (HOE) is sufficient for concentrating most of the illumination light onto the illuminated portion of the total area, i.e. onto the openings of the illumination mask.

When using incoherent illumination, however, the invariance principle of Lagrange prevents such desired light concentration. This principle means that for each illumination beam path the product of the diameter d₁ of the light source and the numerical aperture NA₁ of the light collection optics equals the product of the diameter d₂ of the illuminated area and the numerical aperture NA₂ under which the object is illuminated. In order to be able to illuminate, under a microscope objective having a numerical aperture of 1.2, a spot having a diameter of 0.2 mm, one hence needs a luminous area having a diameter of 3×0.2=0.6 mm, if the collector optics used has a numerical aperture of 1.2/3=0.4.

It is an object of the invention to provide for an illumination arrangement for a microscope requiring structured illumination, in particular for a confocal microscope, comprising an incoherent light source, wherein a local luminous flux as high as possible should be achieved.

According to the invention, this object is achieved by an illumination arrangement as defined in claim 25.

According to this solution the optical arrangement used for imaging the light source onto the illumination mask comprises a plurality of microelements effecting focussing at least in one direction, wherein each opening of the mask is specifically associated with one of the microelements and wherein the optical arrangement is designed for imaging exclusively an area of highest luminous flux of the light source into the respective opening. Thereby it is enabled to choose only the brightest part of an incoherent light source having strongly inhomogeneous brightness for illuminating the specimen, whereby a luminous flux can be achieved in the illumination pattern which is much higher than that which can be achieved with a mask under wide field illumination.

The brightest available incoherent light sources are arc lamps having a luminous area of a diameter of about 0.6 to 2 mm. However, in the luminous area there is no homogenous intensity distribution, rather there is a much brighter “hot spot” very close to one of the two electrodes, with the intensity decreasing in all directions with increasing distance to this “hot spot”. The invention allows to use exclusively the hot spot for illumination by imaging only the hot spot into the illumination openings of the illumination mask, but not the darker area of the arc surrounding the hot spot.

Whereas in case of wide field illumination a more extended field has to be illuminated and to this end also light from darker regions of the arc has to be used, according to the invention, wherein the specimen surface does not have to be illuminated homogeneously, but rather only in portions thereof, illumination modes can be realized by means of optical elements, such as a microlens array, which use the principle of a fly's eye, according to which illumination modes the specimen is illuminated in parallel by many images of the arc, with only the hot spot being used for this purpose.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 schematically shows the beam path and the essential optical elements of a microscope device according to a first embodiment of the invention;

FIG. 2 is a view like FIG. 1, with a second embodiment being shown;

FIG. 3 is a view like FIG. 1, with a third embodiment being shown;

FIG. 4A schematically shows the movement of the specimen and the illumination pattern in the focal plane of the objective and on the detector, respectively, for the case in which the image beam and the illumination beam are caused to completely follow the movement of the specimen;

FIG. 4B is a view like FIG. 4A for the case in which there is no follow-up movement of the image beam and the illumination beam;

FIG. 4C is a view like FIG. 4A for the case of the invention in which the image beam and the illumination beam are caused to follow the movement of the specimen only in part;

FIG. 5 is a schematic view of an example of an incoherent microscope illumination arrangement according to the invention;

FIGS. 6A and 6B are a side view and an elevated view, respectively, of another example of an incoherent microscope illumination arrangement according to the invention; and

FIG. 7 shows another example of an incoherent microscope illumination arrangement according to the invention.

### DETAILED DESCRIPTION OF THE INVENTION

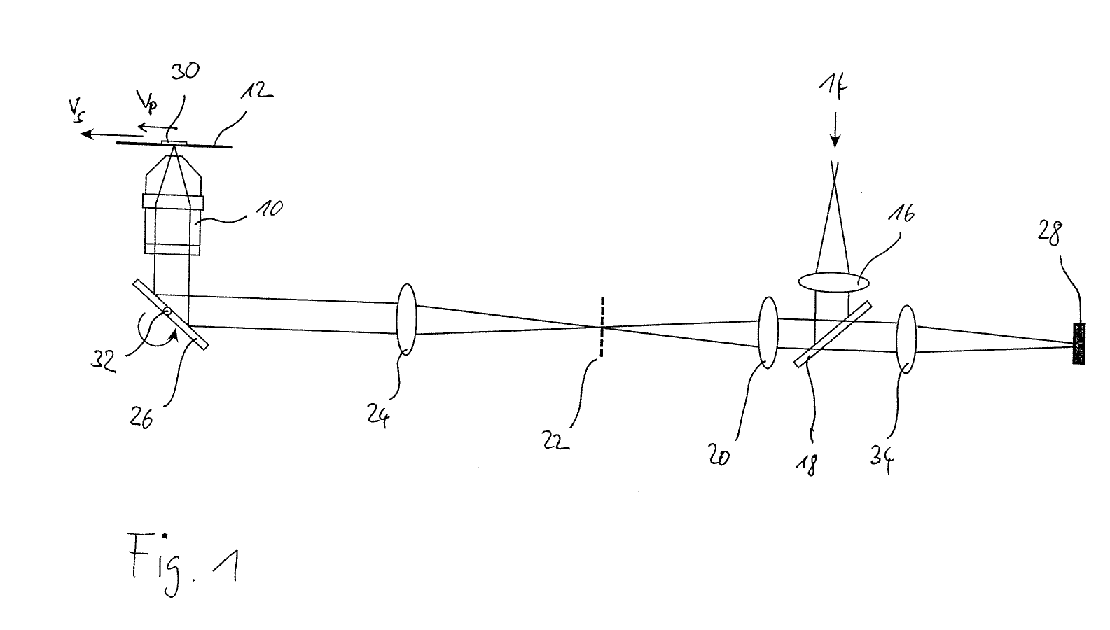

In FIG. 1 a first embodiment of a microscope for observing a specimen 12 moving at a velocity Vₛ in the direction of the arrow perpendicular to the optical axis of the microscope objective 10 is shown. Excitation/illumination light 14 from a light source (which is not shown) is collimated by means of an illumination tube lens 16, it is deflected/coupled by a beam splitter 18 arranged in the collimated beam path, and it is imaged onto a mask 22 by means of a lens 20, wherein the mask 22 generates an illumination pattern and is imaged, by means of a tube lens and the microscope objective 10, onto the specimen 12 located in the focal plane of the objective 10 so as to illuminate the specimen 12 with the illumination pattern.

A beam deflection element 26 is arranged between the tube lens 24 and the objective 10 in or close to a plane conjugated with regard to the objective pupil, which beam deflection element 26 is adjustable in order to move the image field 30, which is illuminated by the excitation light 14 and which is imaged by the microscope onto a detector 28, relative to the specimen 12. The beam deflection element 26 may be, for example, a plane mirror which is rotatable around an axis 32. The imaging of the image field 30 onto the detector 38 is achieved by means of the microscope objective 10, the deflection element 26, the tube lens 24, the lens 20 and an additional lens 34 arranged between the beam splitter 18 and the detector 28. Thereby the light collected by the objective 10 from the specimen 12 also passes through the mask 22, which acts as a confocal aperture for the image beam path. In the example shown the beam splitter 18 is transparent for the light emitted by the specimen, whereas it reflects the excitation light. However, of course, also the reverse configuration is possible. The illumination pattern generated by the mask 22 may be, for example, a line pattern or a spot pattern. The detector 28 may be, for example, a CCD chip capable of shifting the charges, during taking of an image, in a row-wise manner at a velocity which may be selected at least within a certain range. All elements of the microscope device, in particular also the mask 22, are stationary, except for the deflection element 26 and the specimen 12.

By using a fixed mask 22—in contrast to confocal microscopes using linearly movable or rotating masks (Nipkow technology, see, for example DE 198 24 460 A1)—methods for increasing the local luminous flux are simplified.

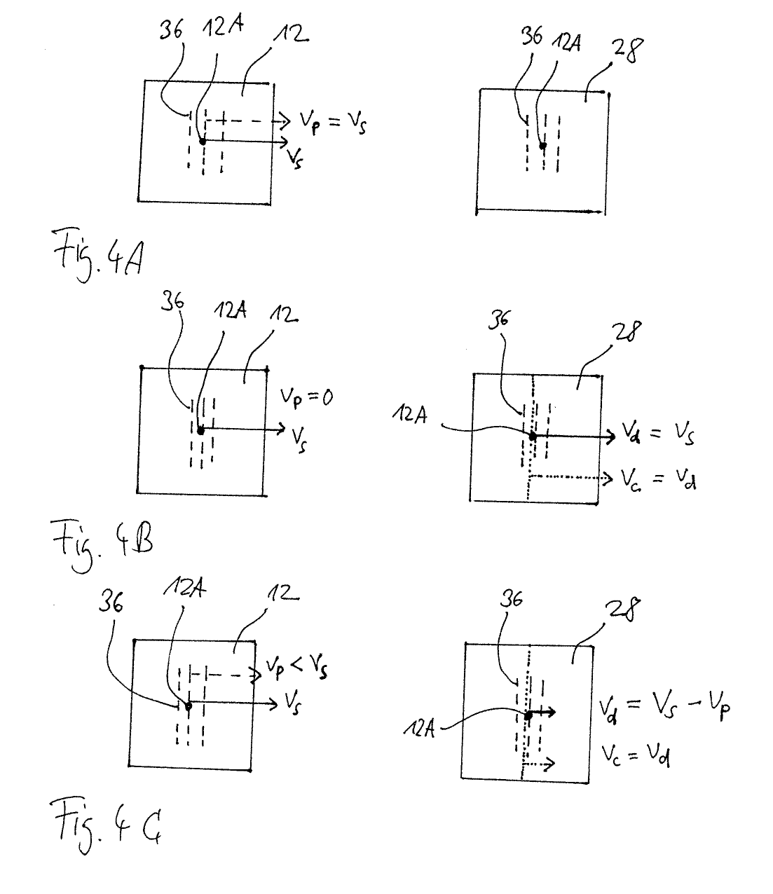

FIG. 4A illustrates a situation, which is not covered by the invention, wherein the beam deflection element is adjusted at such velocity that the follow-up velocity Vₚ corresponds to the specimen velocity Vₛ The specimen 12 including a specimen point 12A and an illumination pattern 36 (dashed lines) are shown in the left part in FIG. 4A, while in the right part of FIG. 4A the image of the specimen area on the detector 28 is shown. Due to the complete follow-up movement of both the image beam and the illumination beam, i.e. the image field 30, according to FIG. 4A both the specimen point 12A and the illumination pattern 36 is stationary with regard to the detector 28. Hence charge shift during taking of an image is not necessary. However, in this case a complete image is only generated if the specimen is illuminated homogeneously, i.e. in the wide field. If, however,—as exemplified in FIG. 4A—an illumination pattern is used, only the areas illuminated by the pattern are bright and hence visible in the image.

In FIG. 4B the case, which is not covered by the invention, is shown, wherein no follow-up-movement oft the image field 30 is provided by the deflection element 26, i.e. the image field is stationary with regard to the objective 10, so that the velocity of the movement of the image field relative to the specimen corresponds to Vₛ. Hence, the pattern 36, as in the preceding case, is stationary on the detector 28; however, now the imaged specimen point 12A moves at a velocity corresponding to the specimen velocity Vₛ across the detector 28 during taking of an image. In order to avoid blurring of the image of the specimen during taking of an image, for example, a row-wise charge shift at the detector 28 at a velocity V_{c} has to occur, which corresponds to the specimen velocity Vₛ (indicated by dots in FIG. 4B).

According to the invention, the microscope device is designed and operated in such a manner that, as illustrated in FIG. 4C, operation takes place in a mode which is in-between the two extreme cases shown in FIGS. 4A and 4B, respectively, i.e. there is some follow-up movement of the image field 30 due to adjustment of the deflection element 26, i.e. the velocity Vₚ of the image field 30 differs from the specimen velocity Vₛ, so that there is always a relative movement between the image field 30 and the specimen 12. The difference V_{d} between the specimen velocity Vₛ and the velocity Vₚ of the image field also corresponds to the velocity at which the specimen point 12A moves across the detector 28.

In order to avoid blurring of the image of the specimen on the detector 28 when taking an image, the charge may be shifted, when using a TDI camera as the detector 28, row-wise at a velocity V_{c}=V_{d} into the same direction. In order to obtain an image of the specimen which is not blurred the condition V_{c}=Vₛ−Vₚ has to be fulfilled, i.e. the velocity of the specimen, the adjustment velocity of the beam deflection element and the charge shift velocity have to be selected such that the velocity of the charge shift compensates for the movement of a point 12A of the specimen 12, which is imaged onto the detector 28, on the detector 28. Since the choice of the adjustment velocity of the deflection element 26 usually does not have to comply with specific limitations, the specimen velocity and the charge shift velocity may be chosen relatively freely corresponding to the choice of the adjustment velocity of the beam deflection element 26, wherein nevertheless a clear image of the specimen is made possible. In particular, a detector 28, for example, may be chosen, which allows for setting the charge shift velocity only at relatively coarse steps or within relatively narrow range.

Also, a relatively high specimen velocity may be chosen irrespective of the imaging requirements in order to achieve a high throughput, since, by a corresponding almost complete follow-up movement of the image field 30, still a relatively low velocity V_{d} of the movement of the specimen across the detector 28 can be realized. Moreover; the adjustment of the deflection element 26 may be used to successively take an image of the same portion of the specimen 12 twice or more times, for example, prior to and after adding a substance to be tested.

Rather than compensating, as described above, the movement of the image of the specimen 12 on the detector 28 by corresponding charge shift by the detector 28 which is designed as a TDI camera, according to a modified embodiment of the invention a two-dimensional detector without TDI charge shift capacity may be used by reading sequentially intermediate images out of the detector 28 during observation, wherein only the illuminated zones (rows) are read out, while the intermediate non-illuminated regions (rows) are binned and are thrown away. A number of such intermediate images may be combined as a final image by relative row-wise shift of the intermediate images, if the specimen velocity, the adjustment velocity of the beam deflection element and the relative row-wise shift are selected such that in the final image the relative row-wise shift acts to compensate the movement of a specimen point, which is imaged onto the detector, on the detector. This method utilizes the effect that, by providing for a partial follow-up movement of the illumination beam path and the image beam path with regard to the specimen movement, the specimen velocity on the detector can be kept so small, irrespective of the velocity of the specimen with regard to the objective, that the image of the specimen does not blur within the exposure time required for taking an intermediate image, i.e. that the image of the specimen on the detector, for example, does not move for more than half of the width of a row (typically the spatial resolution, i.e. the width of a row, of the detector 28 is on the order of the diffraction limitation).

According to all variants, when taking an image of the specimen (i.e. when taking a TDI image or a final image composed of intermediate images) the pattern has to move for at least one period of the pattern (usually the illumination pattern is periodic) relative to the specimen 12, in order to ensure that all specimen points in the illuminated area have been illuminated for the same time period (in the case in which a final image is composed of intermediate images, for example, 20 intermediate images may be taken per period of the pattern (i.e. during the time which is required by a specimen point for passing through one period of the specimen 20 intermediate images are taken)). In general, during the time when an image is taken the pattern should move by a distance relative to the specimen 12 which corresponds to the period length or to an integer multiple of the period length).

The arrangement of FIG. 1, comprising a single mask 22, is beneficial in that it is not necessary to adjust two beam paths to each other; however, it involves the draw-back that the image beam path, which is less intense by many orders of magnitude, has to be passed through the same aperture/mask 22 as the excitation beam path, which fact results in significantly more severe requirements regarding the beam splitter and the blocking filters.

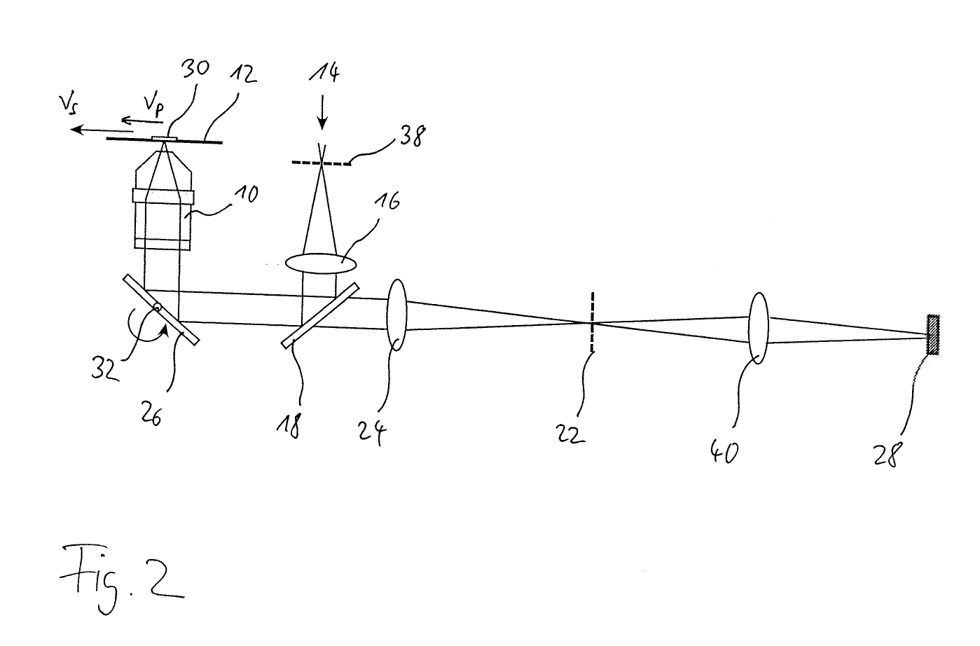

FIG. 2 shows an alternative embodiment, wherein two separate masks/apertures 38 and 22, respectively are provided, with the mask 38 being arranged in the excitation beam path and the mask 22 being arranged in the image beam path. The beam splitter 18 is arranged between the deflection element 26 and the two masks 38 and 22, respectively, with the tube lens 16, 24 being arranged between the beam splitter 18 and the masks 38, 22. The mask 22 is imaged onto the detector 28 by means of a lens 40. The two masks 38 and 22 have to be adjusted exactly to each other in order to achieve the desired confocal imaging.

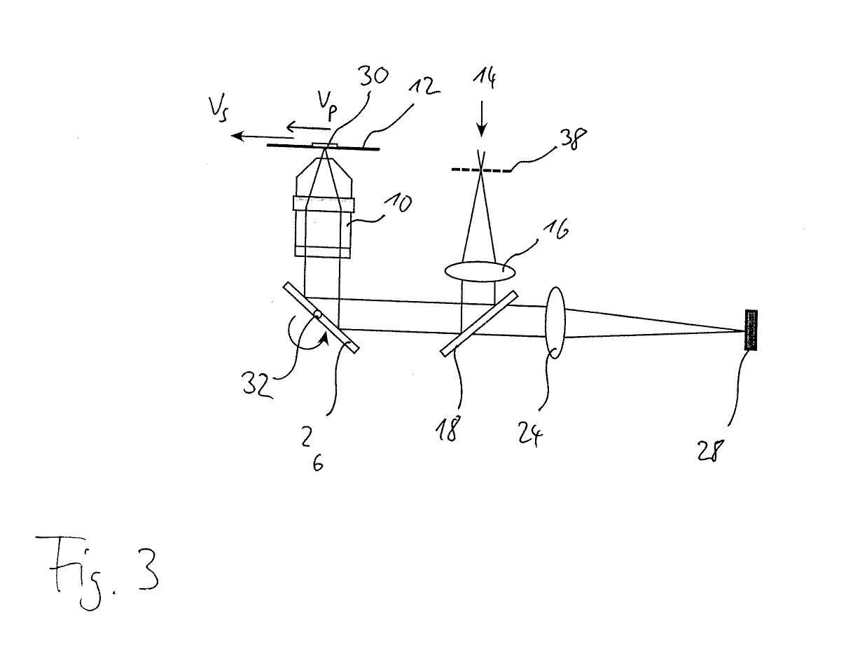

FIG. 3 shows another alternative embodiment of a confocal microscope, wherein the illumination beam path, as in FIG. 2, comprises a mask 38 before the beam splitter 18. However, in this case the mask 22 arranged in the image beam path is omitted, so that neither an imaging lens 40 is provided. Further, only the tube lens 24 is arranged between the beam splitter 18 and the detector 28. According to this embodiment, the effect of the mask 22 of FIG. 2 is achieved by the CCD-chip 28 itself, which is used as an adaptively variable aperture/mask. In this case there is no charge shift. Rather, the final image, as described above, is composed of many intermediate images. However, the intermediate images are not completely read-out, rather only the exposed rows comprising the interesting information from the focal plane of the objective 10 are read-out for the intermediate images, whereas the intermediate rows, which include only information from outside the focal plane, are binned, read-out in an accelerated manner and thrown away. According to a slightly slower variant, one alternatively could read-out also the rows containing information from outside the focal plane and use this information for reconstruction of optimal image information.

As already mentioned, the movement of the image of the specimen 12 on the detector 28 has to be relatively slow, namely so slow that during the exposure time necessary for an intermediate image no significant blurring of the image of the specimen 12 on the detector 28 occurs. Since this relative velocity may be adjusted relatively freely by means of the deflection element 26, despite the required relatively slow relative velocity a high specimen velocity may be realized for achieving high throughput. As already mentioned, the final image is then assembled from the intermediate images, wherein the shift of the image of the specimen on the detector is correspondingly corrected when reconstructing the image.

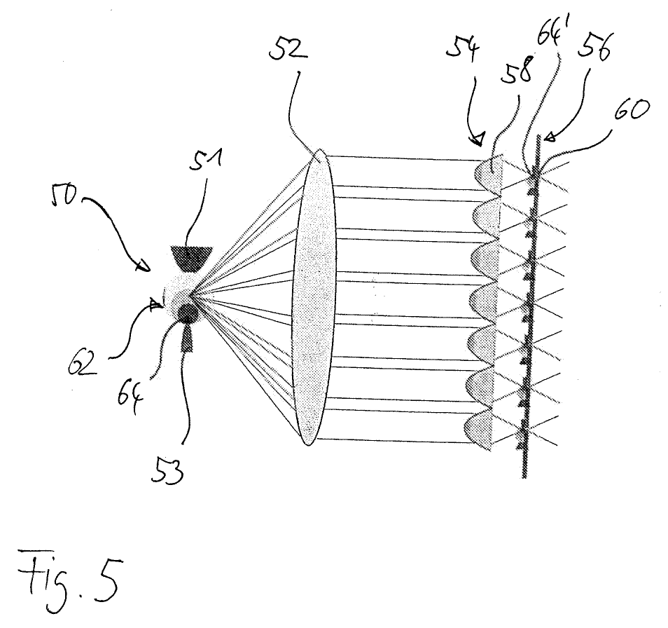

In FIG. 5 a first example of a microscope illumination system according to the invention is shown, wherein an incoherent light source, for example, an arc lamp 50, is imaged onto an illumination mask 56 by means of a collector optics 52 and a microlens array 54. The microlens array 54 consists of a plurality of single lenses 58, which each are associated to one of the illumination openings 60 of the mask 56, in order to image the arc 62 of the arc lamp 50 in such a manner on the respective opening 60 that only the hottest, i.e. the brightest, area 64 falls as an image 64′ within the opening 60, so that the mask 56 serves to block light from the darker areas of the arc 62. The collector optics 52 serve to collimate the light originating in the “hot spot” 64, which then impinges as a parallel beam on the microlens array 54.

The microlenses 58 are designed according to the geometry of the openings 60. For example, if the openings 60 are (circular) holes, the microlenses 58 are lenses which focus in both dimensions, or, if the openings 60 are slits, the microlenses 58 are cylindrical lenses, i.e. lenses which focus only in one dimension. In any case, the microlenses 58 are adjusted to the openings 60.

According to the arrangement shown in FIG. 5, the arc 62 is located in the focal plane of the optics 52, and the mask 56 is located in the focal plane of the microlenses 58. However, alternatively the focal plane of the microlenses 58 could be imaged as an intermediate image on the mask 56 by means of an appropriate optics (not shown).

Imaging of the arc 62 may be chosen, for example, in such a manner that only 10% to 30% of the area between the two electrodes 51 and 53 is imaged into the opening 60, with this area starting at the hotter electrode 53.

The arrangement shown in FIG. 5 may result in the effect that a lot of non-utilised illumination light enters the optical arrangement and may tamper the measurement at the detector as stray light or as disturbing light generating undesired fluorescence.

This can be avoided by providing for a spatial filter already before the microlens arrangement 54, so that only the illumination light originating in the area 64 of maximal luminous flux is utilised for the collimated illumination beam impinging on the microlens arrangement 54, i.e. the (collector) optics 52 is designed such that it blocks, in the light collimated onto the microlens arrangement 54, light originating in the surroundings of the area 64 of maximal luminous flux. This can be achieved, for example, by generating an intermediate image of the luminous area 62 by means of the collector optics 52, with an aperture being provided in the intermediate image plane for blocking light originating in the surroundings of the area 64 of maximal luminous flow. Preferably, a light-guide is used as such aperture, which then in addition may serve to separate the (hot) location of the generation of light from the microlens arrangement 54.

In general, the shown type of incoherent illumination is suitable not only for stationary but also for moving microelements and masks, respectively, i.e. so-called Nipkow-systems.

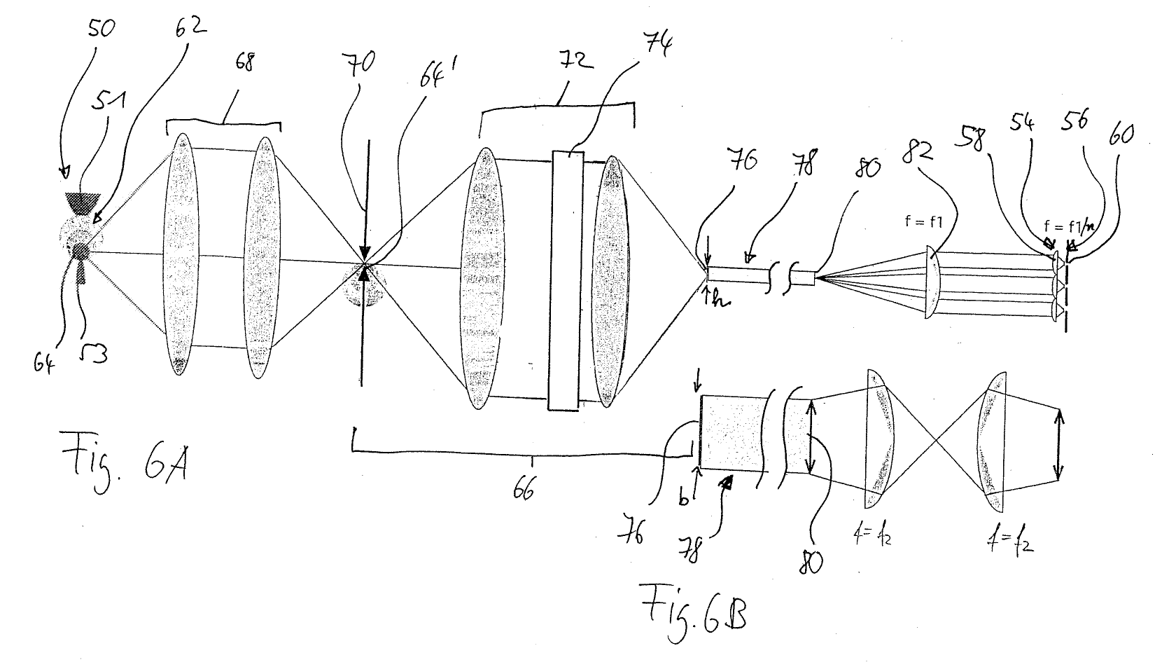

FIGS. 6A and 6B show an embodiment wherein a microlens illumination system is combined with a monochromator 66 in order to achieve a spectrally variable monochromatic illumination of the mask 56. To this end, the arc 62 of the light source 50 first is imaged by means of an optical arrangement 68 in such a manner onto the entrance slit of the monochromator 66 that only light from the hot spot 64 and the image 64 thereof, respectively, passes through the slit 70. The darker areas of the arc 62 hence are blocked by the entrance slit 70, and this occurs not only in one dimension which defines the spectral band width of the subsequent spectrometer arrangement (in FIG. 6A perpendicular to the paper plane), but also perpendicular thereto. The entrance slit 70 hence also “shortens” the slit, in order to allow only transmission of light from the hot spot 64.

The entrance slit 70—and hence the hot spot 64—is imaged onto the light entrance surface 76 of a light-guide rod 78 by means of an optical arrangement 72 comprising an element 74 which acts in a dispersive manner in the direction perpendicular to the paper plane of FIG. 6A. FIG. 6A is a side view of the light-guide rod 78 and the subsequent optics, whereas FIG. 6B shows an elevated view (in FIG. 6B the optics preceding the light guide rod 78 has been omitted). The height h of the light entrance surface 76 preferably corresponds roughly to the size of the image of the hot spot 64 on the light entrance surface 76, i.e. to the length of the entrance slit 70, whereas the width b of the light entrance surface 76 preferably is adjusted to the size of the image of the width of the entrance slit 70 on the light entrance surface 76 (the entrance slit 70 in FIG. 6A extends perpendicular to the paper plane), with the width of the light entrance surface 76 defining the bandwidth of the emerging light.

Thus the light entrance surface 76 of the light-guide rod 78 replaces the exit slit of the monochromator 66. Along the direction of the height h the intensity distribution of the hot spot 64 is maintained when entering into the light guide rod 78, whereas the image of the hotspot 64 is spectrally “blurred” along the direction of the width b, wherein the spectral distribution along the direction of the width b is determined by the geometry of the monochromator 66 and the type of the dispersive element 74. When the light reaches the light exit surface 80 of the light-guide rod 78, the wavelength received over the width b of the light entrance surface 76 have been mixed so far that the light exit surface 80 is illuminated in an essentially homogeneous manner.

The height of the light exit surface 80 is imaged onto a mask 56 having openings 60 by means of a cylinder lens 82 and a cylindrical microlens array 54, which imaging occurs in a manner analogue to that shown in FIG. 5, so that the light exit surface 80 is imaged into each of the openings 60 in order to illuminate the mask 56. The openings 60 are parallel slits. In other words, along the direction of the height h the light exit surface 80 is imaged multiple times by means of the microlenses 58, with each image resting in one of the slits 60.

In total, the imaging optics is designed in such a manner that the light exit surface 80 is imaged by means of crossed cylinder optics into an intermediate image plane in such a manner that the dimension along the direction of the width b is imaged only once, whereas the dimension along the direction of the height h is imaged multiple times, as described above.

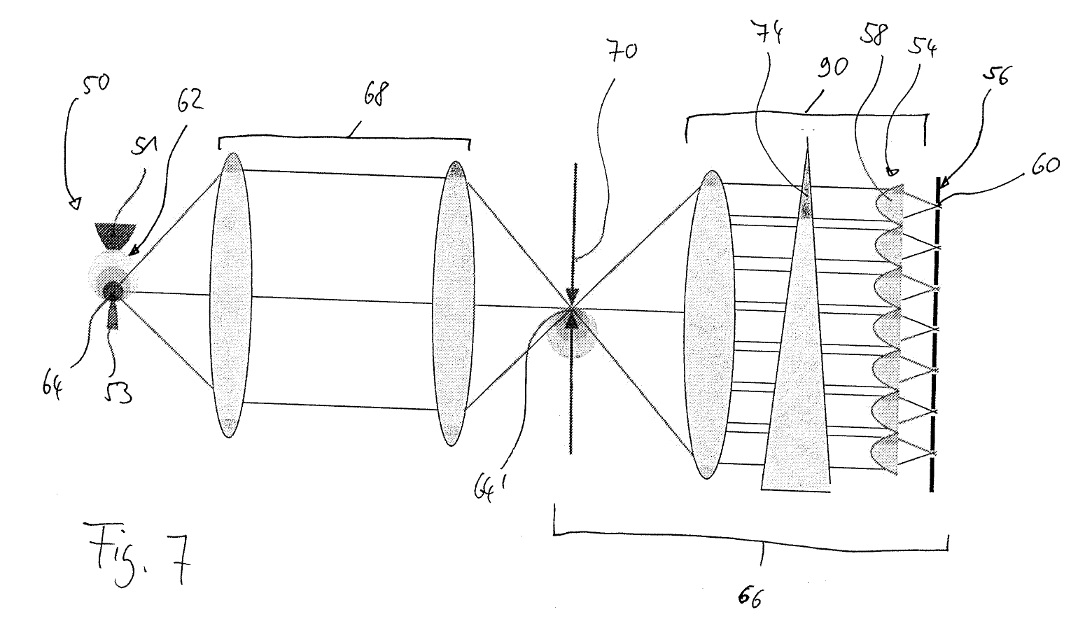

FIG. 7 shows an embodiment wherein a microlens array 54 consisting of cylinder lenses 58 is arranged within a monochromator 66 for achieving further increase of the local luminous flux for illumination by a illumination pattern which has been made monochromatic. To this end, the arc 62 of an arc lamp 50 is imaged in a manner similar to that shown in FIG. 6A onto the entrance slit 70 of a monochromator 66 by means of an optics 68, so that only the hot spot 64 is imaged into the slit openings, with light from the darker areas of the arc 62 being blocked by the entrance slit. In contrast to the arrangement of FIG. 6A, however, the entrance slit 70 extends perpendicular to the paper plane of FIG. 7, so that the limitation shown in FIG. 7 is given by the width of the slit 70, whereas the length thereof may be arbitrary.

The entrance slit 70 is imaged onto the opening 60 of a mask 56 by means of an optics 90 comprising an element 74 acting as a dispersive element along the direction of the beams shown in FIG. 7 and the microlens array 54, wherein the openings 60 are designed as slits and the microlenses 58 are designed as cylinder lenses, as mentioned above, and wherein a cylinder lens 58 is associated to each of the slits 60. Thereby the entrance slit is imaged into each single slit 60 of the mask 56. Thus, an arrangement is achieved which may be conceived as consisting of many monochromators operated in parallel, with the slits 60 forming the exit slits of these monochromators.

When using such an arrangement, a much lower dispersion is required compared to an arrangement wherein the exit slit serves to illuminate the entire object field. Thus, rather than using a diffraction grating, a dispersion prism may be used as the dispersive element 74, having a wavelength-independent efficiency of almost 100%, wherein the dispersion prism may be manufactured by combining different types of glass having approximately liner dispersion, if, as in this case, only low dispersion is necessary. By rotating the prism 74 or by changing the angle at which the light passes through the prism 74, the wavelength of the light passing through the slits 60 of the illumination mask 56 may be adjusted continuously.

It is to be understood that the masks 56 of the embodiments of FIGS. 5 to 7 could be used, for example, as the mask 38 of the confocal microscope devices of FIGS. 2 and 3.

While various embodiments in accordance with the present invention have been shown and described, it is understood that the invention is not limited thereto and is susceptible to numerous to numerous changes and modifications as known to those skilled in the art. Therefore, this invention is not limited to the details and described therein, and includes all such changes and modifications as encompassed by the scope of the appended claims.

What is claimed is:

1. A microscope device comprising an objective, a light source for illuminating a specimen via an illumination beam path, an arrangement for continuously moving the specimen during observation in a direction perpendicular to an optical axis of the objective, a two-dimensional detector for detecting light coming from the specimen via an image beam path, said detector being capable of shifting charges during observation in a row-wise manner in the direction of the movement of the specimen on the detector, a beam deflection element which is adjustable for moving the illumination beam path and the image beam path during observation relative to the specimen in the direction of the movement of the specimen, and a control unit for selecting the velocity of the specimen, the adjustment velocity of the beam deflection element and the charge shift velocity in such a manner that the charge shift velocity acts to compensate the movement of a point of the specimen, which point is imaged onto the detector, on the detector.

2. A microscope device comprising an objective, a light source for illuminating a specimen via an illumination beam path, an arrangement for continuously moving the specimen during observation in a direction perpendicular to an optical axis of the objective, a two-dimensional detector for detecting light coming from the specimen via an image beam path, a beam deflection element which is adjustable for moving the illumination beam path and the image beam path during observation relative to the specimen in the direction of the movement of the specimen, and a control unit for sequentially reading-out intermediate images from the detector during observation and for combining the intermediate images into a final image by applying a relative row-wise shift of the intermediate images, and wherein the control unit is designed for selecting the velocity of the specimen, the adjustment velocity of the beam deflection element and said relative row-wise shift in such a manner that in the final image the relative row-wise shift acts to compensate the movement of a point of the specimen, which point is imaged onto the detector, on the detector.

3. The microscope device of claim 2, further comprising a beam splitter for separating the illumination beam path and the image beam path, wherein the beam deflection element is arranged between the objective and the beam splitter.

4. The microscope device of claim 1, wherein the beam deflection element is located in or close to a plane conjugated with regard to a pupil of the objective.

5. The microscope device of claim 1, wherein the beam deflection element is a rotatable plane mirror.

6. The microscope device of claim 1, wherein the device is designed for wide field illumination of the specimen.

7. The microscope device of claim 3, wherein the microscope device is confocal.

8. The microscope device of claim 7, wherein a fixed mask is arranged in the illumination beam path in a plane conjugated with regard to an object plane, wherein the mask is imaged onto the specimen and wherein the image of the mask on the specimen is moved by the beam deflection element during observation relative to the specimen in the direction of the movement of the specimen.

9. The microscope device according to claim 8, wherein the mask is designed for generating a pattern which is periodic in the direction of the movement of the specimen, and wherein the control unit is designed in such a manner that the image of the mask on the specimen moves during observation by at least one period of the pattern relative to the specimen.

10. The microscope device of claim 8, wherein the mask forms a line pattern or a spot pattern.

11. The microscope device of claim 8, wherein the mask is arranged between the beam deflection element and the beam splitter and thus is arranged both in the illumination beam path and the image beam path.

12. The microscope device of claim 11, wherein the mask is arranged in a plane conjugated with regard to the detector.

13. The microscope device of claim 12, wherein a tube lens is arranged between the mask and the beam deflection element.

14. The microscope device of claim 8, wherein a fixed mask is arranged in the image beam path in a plane conjugated with regard to the plane of the mask arranged in the illumination beam path, and wherein the mask arranged in the image beam path is adjusted to the mask arranged in the illumination beam path.

15. The microscope device of claim 14, wherein the mask arranged in the image beam path is imaged onto the detector.

16. The microscope device of 15, wherein the beam splitter is arranged between the beam deflection element and each of the two masks.

17. The microscope device of claim 8, wherein the control unit is designed for using from each intermediate image for the final image only certain areas which are selected for imitating a confocal aperture adjusted to the mask arranged in the illumination beam path.

18. A method for observing a specimen by means of a microscope device comprising an objective, wherein the specimen is illuminated via an illumination beam path, wherein the specimen moves in a direction perpendicular to an optical axis of the objective during observation, wherein light coming from the specimen via an image beam path is imaged onto a two-dimensional detector, with the charges on the detector being shifted row-wise in the direction of the movement of the specimen on the detector during observation, wherein the illumination beam path and the image beam path are moved during observation relative to the specimen in the direction of the movement of the specimen by adjusting a beam deflection element, and wherein the velocity of the specimen, the adjustment velocity of the beam deflection element and the charge shift velocity are selected in such a manner that the charge shift velocity acts to compensate the movement of a point of the specimen, which point is imaged onto the detector, on the detector.

19. A method for observing a specimen by means of a microscope device comprising an objective, wherein the specimen is illuminated via an illumination beam path, wherein the specimen moves in a direction perpendicular to an optical axis of the objective during observation, wherein light coming from the specimen via an image beam path is imaged onto a two-dimensional detector, wherein the illumination beam path and the image beam path are moved during observation relative to the specimen in the direction of the movement of the specimen by adjusting a beam deflection element, wherein intermediate images are sequentially read-out from the detector during observation, wherein the intermediate images are combined into a final image by applying a relative row-wise shift of the intermediate images, and wherein the velocity of the specimen, the adjustment velocity of the beam deflection element and said relative row-wise shift are selected in such a manner that in the final image the relative row-wise shift acts to compensate the movement of a point of the specimen, which point is imaged onto the detector, on the detector

20. The method of claim 19, wherein the microscope device is confocal, wherein a fixed mask is arranged in the illumination beam path in a plane conjugated with regard to an object plane, which mask is imaged onto the specimen and wherein the image of the mask on the specimen is moved relative to the specimen in the direction of the movement of the specimen by a beam deflection element during observation.

21. The method of claim 20, wherein the mask is designed for generating a pattern which is periodic in the direction of the movement of the specimen, and wherein the image of the mask on the specimen moves during observation for at least one period of the pattern

22. The method of claim 21, wherein only certain areas of each intermediate image are used for the final image, which areas are selected in order to imitate a confocal aperture adjusted to the mask in the illumination beam path.

23. The method of claim 19, wherein the velocity of the specimen and the adjustment velocity of the beam deflection element are selected such that the image of the specimen on the detector does not move by more than half of the width of a row during the exposure time period required for taking an intermediate image.

24. The method of one of claim 18, wherein the specimen moves continuously in the same direction perpendicular to the optical axis of the objective, while a given area of the specimen is observed multiple times in the same manner by means of the detector by corresponding adjustment of the beam deflection element.

25. An illumination system for a microscope, comprising an incoherent light source having inhomogeneous luminous flux, a mask which is to be arranged in an illumination beam path of the microscope and which comprises a plurality of openings for forming an illumination pattern on a specimen to be examined, and an optical arrangement for imaging the light source onto the mask, wherein the optical arrangement comprises a plurality of microelements for focussing light in at least one dimension, wherein each opening of the mask is specifically associated with one of the microelements, and wherein the optical arrangement is designed for imaging exclusively an area having maximal luminous flux of the light source into each of the openings.

26. The illumination system of claim 25, wherein the light source is an arc lamp comprising two electrodes and wherein said area of maximal luminous flux terminates at one of the two electrodes and comprises not more than 10% to 30% of the distance between the two electrodes.

27. The illumination system of claim 25, wherein each opening is arranged in a focal plane of the associated microelement.

28. The illumination system according to claim 25, wherein the entire luminous surface of the light source is imaged onto the mask and wherein only the image of said area of maximal luminous flux falls within the respective opening, so that each opening acts as an aperture for blocking light from the surroundings of said area of maximal luminous flux.

29. The illumination system of claim 28, wherein the openings are slits and wherein the microelements are formed by a cylinder microlens array adjusted to the slits.

30. The illumination system of claim 28, wherein the openings are circular holes and wherein the microelements are formed by a microlens array adjusted to the holes.

31. The illumination system of claim 25, wherein the light source is imaged in such a manner onto an entrance slit of a monochromator that only said area of maximal luminous flux falls within the entrance slit, wherein the entrance slit is imaged into the respective opening of the mask by means of the microelements, and wherein the openings of the mask are formed by slits adjusted to the entrance slit and act as parallel exit slits of the monochromator.

32. The illumination system of claim 31, wherein the microelements are formed by a cylinder microlens array adjusted to the slits of the mask.

33. The illumination system of claim 31, wherein all dispersive elements of the monochromator are located between the entrance slit and the microelements.

34. The illumination system of claim 33, wherein the dispersive element of the monochromator is a prism.

35. The illumination system of claim 34, wherein the prism is formed by a combination of different types of glass for having a dispersion which is at least approximately linear.

36. The illumination system of claim 25, wherein the light source is imaged onto the entrance slit of a monochromator in such a manner that only said area of maximal luminous flux falls within the entrance slit, wherein the entrance slit is imaged onto a light entrance surface of a light guide rod, which light entrance surface acts as the exit slit of the monochromator, in such a manner that in the dimension of the light entrance surface perpendicular to the dispersion of the monochromator only said area of maximal luminous flux impinges on the light entrance surface, wherein the light-guide rod is designed such that due to internal reflection at its light exit surface an essentially homogeneous light distribution is created, wherein the openings of the mask are adjusted to the light exit surface of the light-guide rod, and wherein the light exit surface of the light guide rod is imaged onto each of the openings by means of the micro elements.

37. The illumination system of claim 36, wherein the openings of the mask are formed by slits adjusted to the light exit surface of the light-guide rod and wherein the microelements are formed by a cylinder microlens array adjusted to the slits of the mask.

38. The illumination system of claims 25, wherein the optical arrangement comprises a collector optics for collimating light from said area of maximal luminous flux of the light source onto the microelements and for blocking light from the surroundings of said area of maximal luminous flux.

39. The illumination system of claim 38, wherein the collector optics generates an intermediate image of the luminous area of the light source and wherein an aperture is arranged in the plane of the intermediate image for blocking light from the surroundings of said area of maximal luminous flux.

40. The illumination system of claim 39, wherein the aperture is formed by a light-guide.
